(19) United States
(12) Patent Application Publication
(10) Pub. No.: US 2007/0246145 A1
(43) Pub. Date: Oct. 25, 2007

(54) Method for installation of natural stone surfaces

(76) Inventor: David M. Feiertag, Ft. Myers, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/409,900

(22) Filed: Apr. 24, 2006

(51) Int. Cl. B32B 37/12; B32B 38/10; B32B 38/04

(52) U.S. Cl. 156/71; 156/258; 156/154

(57) ABSTRACT

A method for installing natural stone surfaces is disclosed wherein the natural stone is provided with a thickness cut from its quarried block, which is between about ⅜ inch to about ⅝ inch thick. It is sized so that an installer can handle and install the natural stone surface on the job site without the use of an off-site fabrication shop. When the natural stone surface needs to be cut on the job site, the thickness allows an installer to make the cuts using a wet or dry rotary saw, as appropriate. Desired cut edges are then polished to a desired finish. Where desired, a natural stone prefabricated edge is installed against edges of the natural stone surface. The prefabricated edge is adhesively applied to the natural stone surface edge using a resinous material. The seam is then polished as needed.

### FIELD OF THE INVENTION

The invention relates generally to natural stone sourcing and installation on different surfaces.

### BACKGROUND OF THE INVENTION

By way of background, the following are examples of outlines of typical materials and installation procedures used in the art presently. Typically, imported natural stone comes in two thicknesses, 3 cm thick and 2 cm thick or from about 1¼ inch thick to about ¾ inch thick. The following includes current estimated prices for such material.

1. Regular procedure to process natural stone surfaces (3 cm @ $2.00 USD per square foot of freight):

Regular slabs of 3 cm thickness are used in this case. These slabs are imported from many different countries. A regular fabrication shop will sell the project, calculate the number of slabs that will be used on the project, buy from local distributors and start the process of fabrication.

The template crew will go to the project to make the templates and then bring the templates to the shop. The slabs are placed on a saw table for cutting. The template is set on the top of the slab on the table and marked to be cut and the slabs are cut to template. Every different piece is taken separately to the fabrication table to be edged. Then the pieces are taken to another table to be polished. After this process is complete, the installers take the fabricated pieces to the job site to be installed.

2. Regular procedure to process natural stone surfaces (2 cm @ $1.50 USD per square foot of freight):

Regular slabs of 2 cm thickness are used in this case. Again, these slabs are imported from many different countries. A regular fabrication shop will sell the project, calculate the number of slabs that will be used on the project, buy from local distributors and start the process of fabrication.

The template crew will go to the project to make the templates and then bring the templates to the shop. The slabs are placed on a saw table to be cut. The template is set on the top of the slab on the table and marked to be cut. Then the slabs are cut to template. Three inches pieces are cut to laminate and double the thickness of the edge. After glued and laminated the pieces go back to the saw table to be cut again and to take the excess out. Every different piece is taken separately to the fabrication table to be edged. Then the pieces are taken to another table to be polished.

After this process is complete, the installers will take those pieces to the job site to be installed.

Describing now the installation of a 3 cm thick slab, there are special automated procedures needed to process such natural stones. A “CNC” automated machine that typically cost over $150,000 is needed in this case. After the template crew brings the template back to the fabrication shop, the slabs are taken to the “CNC” automated machine. A very well trained professional will be adding the measurements of the templates to the computer of the machine. After the program inputting is completed, the process of fabrication begins, with no need of a fabricator helper that is avoided in this case.

After all this process, the installers take the fabricated pieces to the job site to be installed. This seemingly simple process is more efficient for line of production of certain products like big hotels vanities, etc. However, this is different than most jobs, which require customization and take a long time to program and schedule also it can not avoid any imperfection on the slab so it has to be perfect.

The very heavy and delicate pieces are put in the truck and tied to support the long journey to the job site. Most of the jobs need a crew of 2 or 3 people to install and finish the installation. The pieces are taken to the right place, glued, caulked and all necessary adjustments, seams and little details are completed at the job site. For instance any mistake, crack, broken piece, broken back splash, mistake on angles measurements or template mistakes will result in the crew having to go back to the shop, order another fabrication and schedule all over again. (This is valid for all the procedures above.)

There are special requirements needed to complete the above described procedures. The fabrication shop has to be located at an industrial zone due to zoning requirements. Environmental issues must be addressed including permitting/licenses for operating a fabrication shop and for recycling hazardous waste and water recycling. Heavy and expensive equipment such as forklifts, cutting machines, and other typical the fabrication shop machinery required to completely process natural stone for installation. Concerning manpower, a template crew is required, a fabrication crew is required, a technically trained programmer for the “CNC” machine programming is required, expensive liability insurance and workmen's compensation insurance is required, and fabrication shops typically have a stressful, dirty and noise work place and have high work place incidents of injuries. In addition, a relatively large payroll is required to maintain a fabrication shop. Other associated factors that impact overall costs are: the high quantity of waste and left over pieces that can never be used, lost sales due to high cost estimates, inventory cost is high and a separate installation crew must be utilized that can work with the fabrication shop workers.

Also, one other factor that needs to be considered is the source of the natural stone material. Stone is typically quarried in blocks. A block is typically about 110 inches long by about 70 inches wide with a thickness that provides for a total volume of about 10-12 cubic meters. These blocks must be cut into slabs. Almost every country that exports slabs has a facility with the special sawing machine that can cut these quarried stones to slab thicknesses. Such a sawing machine can cost over $500,000.00, so as one can imagine, there are not many such facilities that can cut these blocks. For example, if 3 cm thick slabs are desired, then about 50 slabs might be obtained from a standard block. If 2 cm thick slabs are desired, then about 75 slabs might be obtained from a standard block. If, as described below for the invention, a thinner slab was desired such as about 1.27 cm or about ½ inch thick, then about 90 slabs could be obtained from a typical block and also use the lower quality blocs that will be possible due to the sizes of the slabs that will be used in the new process, those are going to have different measurements.

What is needed is a method of using natural stone surfaces that does not require the need to utilize the services of a fabrication shop utilizing high cost and labor intensive template making, lots of waste, cutting and transporting charges that are passed on to the consumer.

### SUMMARY OF THE INVENTION

As alluded to above, the present invention is a method that avoids the use of several steps typically associated with an industrial fabrication shop and the associated high cost with such operations and its inevitable impact on the cost to the consumer for installing such beautiful natural stone surfaces on countertops, table tops and cabinet tops. First, what is needed is material that can be handled and worked by installers at the work site using simple wet saws or dry saws, typically diamond bladed. What is needed is material that is thinner than that used presently in form of blanks and different sizes that will need only few touch up cuts.

The novel method involves the installation of natural stone tops and natural stone prefabricated edges that will be seamed together on the job site. After the installing of the top, the edge (facing) is added and most of the installation procedures are done at the job site. The edging may be designed with a decorative form to achieve a desired appearance or theme, similar to what can be achieved with wood molding with many different choices of thickness color shape, etc.

Material can be quarried and produced worldwide according to predetermined specifications that will enable an installer to completely install the material without the need for a fabrication shop. The key is to obtain from quarries, a thinner material than what is currently be provided by worldwide quarries already cut to blancs. Because thinner material is required, most will already be cut to sizes easier to work with, thus avoiding waste and enabling the use of lower quality blocs, and the thinner material and different sizes of edges (2 cm to 15 cm) will be sent to distribution warehouses. Consumers and local contractors will be able to place orders through authorized and licensed sales representatives, department stores, show rooms, hardware stores, furniture stores, cabinet shops, pool builders, tile stores, natural stone suppliers and distributors, and even garden stores. As one can surmise, the distribution chain is more consumer friendly because the thinner slabs are lighter and easier to handle, can be stored and inventoried without the need for heavy industrial equipment required to handle the heavier thicker slabs and the obvious overall cost of material is also beneficial to the employee, and it could be even installed by the homeowner making it even more affordable.

The invention contemplates slabs being sawed from blocks, but at thinner thicknesses, preferably ranging from about ⅜ inch thick (about 1 cm) to about ⅝ inch thick (about 1.6 cm). An ideal contemplated optimal thickness is about ½ inch thick slabs (about 1.27 cm) for countertops, cabinet tops, table tops, etc.

As mentioned above, the novel method includes adding a natural stone pre-fabricated edge, that can be massed produced and as such, results in significant cost reduction) to a separately cut to size natural stone surface top, which has been installed. The edging is seamed together to the already installed top using adhesive or glue material, and the final finishing and polishing can be completed at the job site. Typically the edging is installed so that the top surface of the natural stone top is level with the top surface of the edge, when seamed together. Any difference in overall thickness of the edging greater than the thickness of the natural stone top is allowed to extend or depend below the level of the bottom surface of the natural stone top, allowing it to cover even old surfaces. After the polishing step is complete, the seam is blended in the natural stone so that it is typically not observable.

The edge material can be applied to kitchen countertops, vanities, bar tops, office table, regular tables, pools, tubs, stairs, patio table tops and window sills. It will be added using a colored resin to glue it together with a very thin joint. The edge could be any thickness and the thicker it is, it will look more customized and fine, like a very expensive work that will cost much less than what the installation of the present day tops costs. In addition, other benefits are lots of different choices of edging thickness, color mixing, different stone mixing, combination of different designs and more options for the designers and decorators. Of course, a thicker (or wider) edge when attached to the edge face of the natural stone surface, will make the surface appear to be significantly thicker than its actual thickness and its resultant appearance will therefore seem to be worth much more than what it will actually cost the consumer.

With the inventive method herein, the time reduction for fabrication and installation will be very significant, the high overhead of a fabrication shop will become unnecessary, the cost of layout, transportation and warehousing will reduce considerably because the thinner slabs and sizes that would be imported. These products will now become more affordable because of the cost reduction and the demand will increase considerably due to the affordability, beauty and quality. Workers also benefit as there is increase work for workers of stones and tiles and other related areas. Even a homeowner will be able to install the natural stone top using an installation kit and instructions. These thinner tops could be installed on top of existing tops because the new edge will cover the old edge and its light weight (thinner slabs). The waste is reduced significantly because the blanks, sizes smaller than current slab sizes, will be made with desired standard measurements avoiding the rough edge and cuts at the shop. Of course, waste is reduced just from the use of thinner material.

For comparison purposes using typical current costs in the example below, it is anticipated that there would be an appropriate 40 percent cost reduction between the traditional method using 3 cm thick slabs and the new method using ½ inch thick slabs. Because the retailer's cost is impacted by the cost at the fabrication shop, a retailer's cost is about $58.45 per square foot for the traditional method while his cost is about $35.68 using the inventive, less labor intensive method.

Another contribution to the cost reduction noted in the example above is that in the new method, the cost of blocks can be reduced by about 60% because the traditional method requires first quality blocks while with the new method, lower quality blocks (second and third quality) will be used. The reason is that different size blanks can be produced instead of the full size slabs. In addition, the thinner cut slabs can be more readily converted to into tiles and sold while the 3 cm slabs would be very expensive to turn into thin tiles. Although 2 cm slabs could be turned into tiles, the full slabs still have to be top quality to be used in the process.

### BRIEF DESCRIPTION OF THE DRAWINGS

In the accompanying drawings:

FIG. 1 is a perspective conceptual view of a typical cabinet showing the natural stone top and its front edge facing glued on and the two side edges detached ready for gluing on the respective edges of the main stone top surface;

FIG. 2 is a conceptual depiction of a natural stone top with an example of a designed type of edging readied to be glued, in this case to the front and right side edge of the top surface;

FIG. 3 is a depiction similar to FIG. 2, depicting another example of edging to be glued to the top surface with the right side already glued and the front facing ready to be glued to the top surface;

FIG. 4 is a depiction similar to FIGS. 2 and 3, depicting another example of cut edging, this time with a 45 degree corner, and the front and side edges both being glued on;

FIG. 5 is a depiction of the invention showing an example of a finished product similar to FIG. 4, with the seams being polished so as not to be readily visible; and

FIG. 6 is a depiction of a conceptual addition of a section of natural stone to extend a length of the stone.

### DETAILED DESCRIPTION OF THE INVENTION

The invention is more specifically described as a method for installing natural stone surfaces as table tops, bar tops regular tables, pools, tubs, stairs, patio table tops, window sills, and countertops for cabinets, and vanities. The method comprises providing a natural stone surface having a desired thickness cut from its quarried block. The desired thickness is between about ⅜ inch to about ⅝ inch thick, and the natural stone surface is sized so that an installer can handle and install the natural stone surface on the job site without the use of an off-site fabrication shop.

When the natural stone surface needs to be cut on the job site, the cutting process can be done on the job site using a wet or dry rotary saw, as appropriate.

The method further comprises polishing desired cut edges to a desired finish.

When applicable, the method further comprises installing a natural stone prefabricated edge against edges of the natural stone surface, wherein the prefabricated edge is adhesively applied to the natural stone surface edge using a resinous material of a desired resin color so as to blend in with a color of the natural stone surface; and polishing the resultant seam so as to blend said seam so as not to be readily noticeable. Typically, the natural stone prefabricated edge has a thickness equal to or greater than a thickness of the natural stone surface.

It is anticipated that the preferred desired thickness of the natural stone surface is about ½ inch thick or its approximate equivalent in centimeters.

The accompanying drawings are intended to depict examples of natural stone surfaces as a top on a vanity cabinet or as a top to be used as a table top. The drawings do not depict the cutting process using a rotary wet or dry blade as this process is well known in the art and typically used by tile cutters installing tiles on a job site.

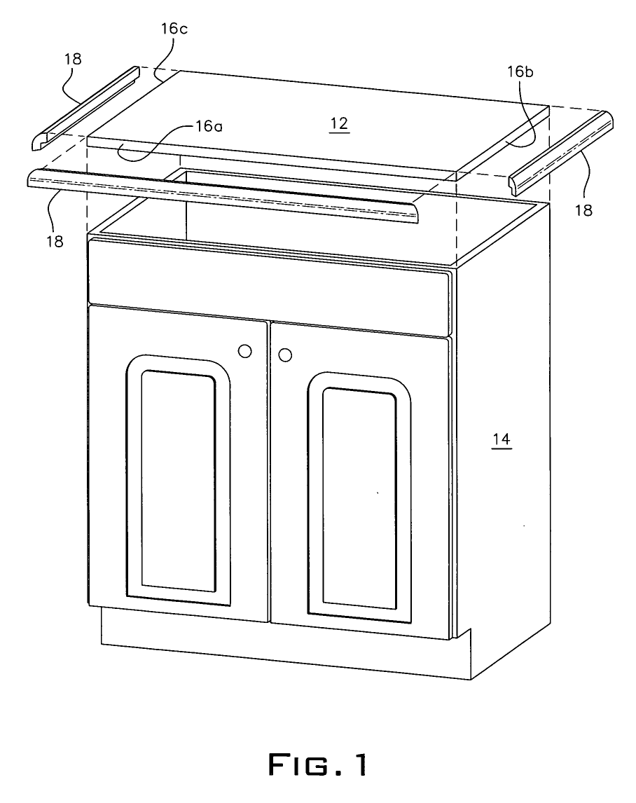

Referring now to the drawings, FIG. 1 discloses one example of an embodiment of the present invention, wherein a natural stone surface 12 is being installed as a top for a vanity cabinet 14. In the example, the front side edge, two side edges and back side edge, 16a, 16b, 16c, 16d respectively, of the natural stone surface are flat. In this example, it is planned to install prefabricated moldings (also referred to herein as facings or edges) to the front side and two side edges 16a, 16b, 16c.

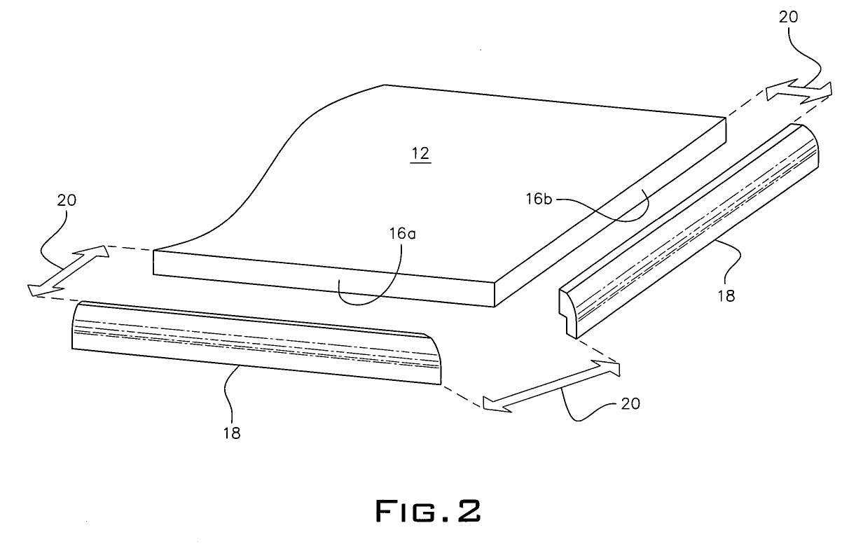

FIG. 2 depicts the natural stone surface only with the front side and right side edges 16a, 16b designated to receive respective prefabricated edges 18. In this case, the contemplated joint seams 20 are contemplated to be at 45 degrees for the corner and normal longitudinal joint seams for the front and right side. The colored resinous adhesive material is not shown for clarity but is fully understood to be used in the finishing process. The depicted prefabricated edges 18 are representative of different forms that may be wider than the thickness of the natural stone surface 12. In this case, the top of the edge 18 is typically flush with the top of the natural stone surface 12 and the extra width depends below the thickness of the surface 12 to provide for a finished product which appears to be a much thicker natural stone surface 12.

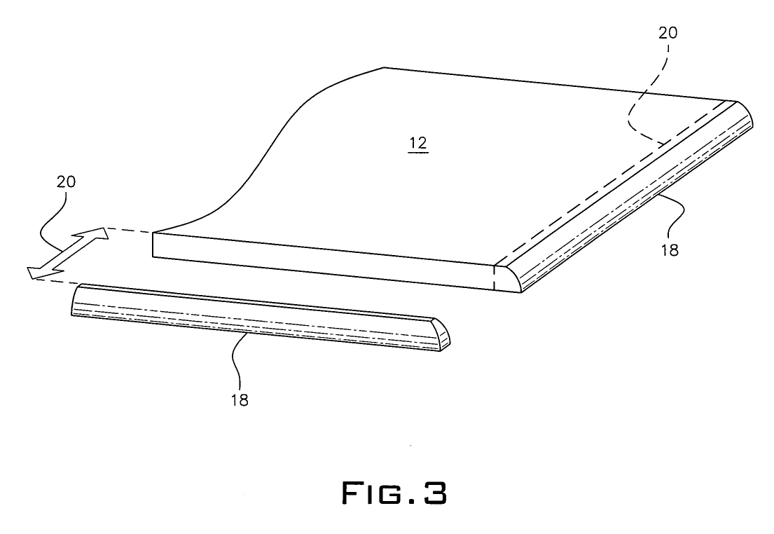

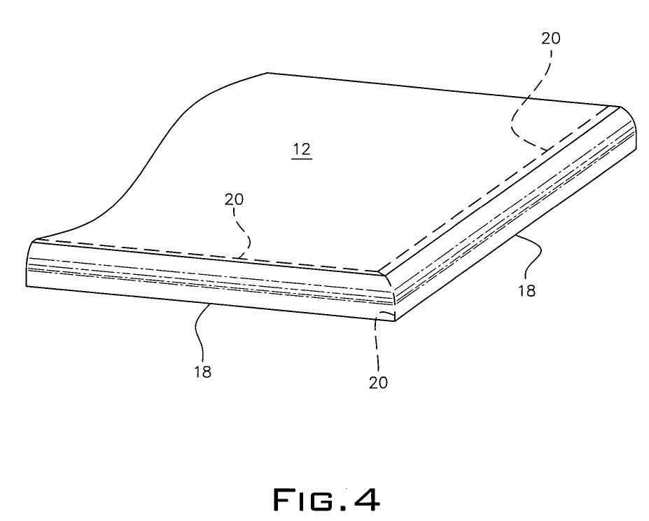

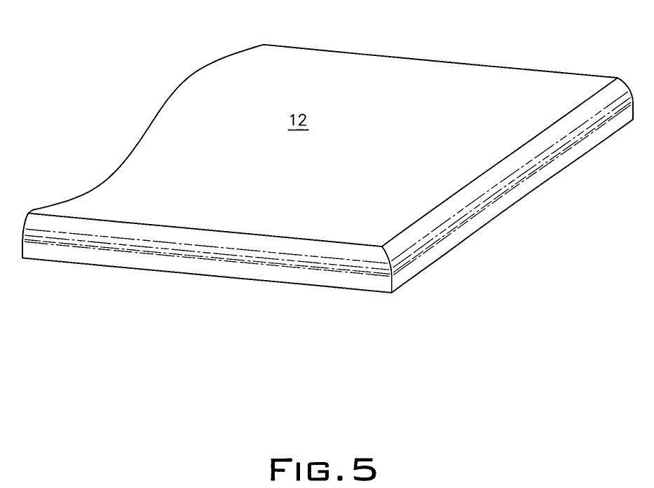

FIG. 3 depicts another example of a natural stone surface 12 where the right side prefabricated edge 18 has already been glued to the surface 12 (see seam line 20). The front side prefabricated edge 18 is to glued to the front side 16a and in this case, the prefabricated edge 18 has a thickness corresponding to the thickness of the natural stone surface 12. FIG. 4 depicts an embodiment similar to the embodiment of FIG. 3, except that the seaming process has been completed and the corner is made at a 45 degree angle. FIG. 5 depicts an example of a finished top 12 with seams no longer visible due to the final polishing treatment.

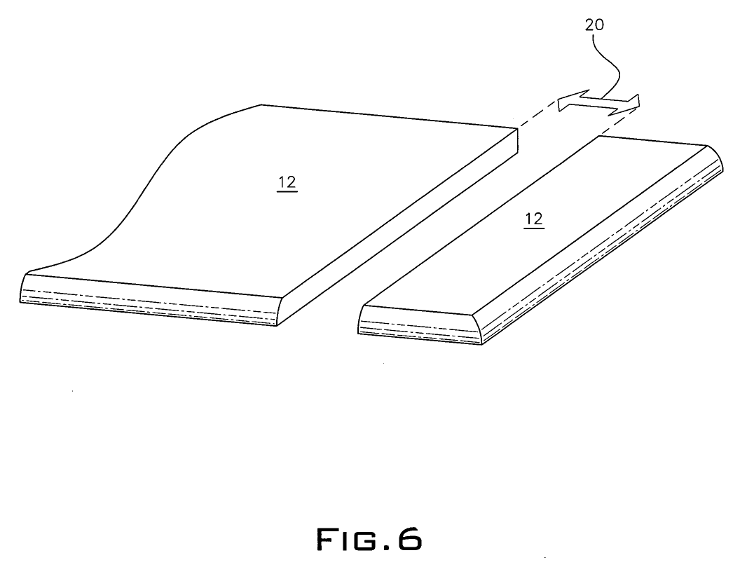

FIG. 6 is a depiction of a conceptual addition of a section of natural stone 12 to extend a length of the stone, which would result in a finished product similar to that depicted in FIG. 5, except longer. This is an example of how standard size slabs could be made and later joined together to form longer end products or products that turn at an angular direction, like a 90 degree turn.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1 . A method for installing natural stone surfaces as table tops, bar tops regular tables, pools, tubs, stairs, patio table tops, window sills, and countertops for cabinets, and vanities, the method comprising:
providing a natural stone surface having a desired thickness cut from its quarried block, said desired thickness being between about ⅜ inch to about ⅝ inch thick, wherein the natural stone surface is sized so that an installer can handle and install the natural stone surface on the job site without the use of an off-site fabrication shop; and
installing the natural stone surface where desired.

2. The method according to claim 1, wherein when the natural stone surface needs to be cut on the job site, said cutting process is done on the job site using a wet or dry rotary saw, as appropriate.

3. The method according to claim 2, further comprising polishing desired cut edges to a desired finish.

4. The method according to claim 1, further comprising:
installing a natural stone prefabricated edge against edges of the natural stone surface where desired, wherein said prefabricated edge is adhesively applied to the natural stone surface edge using a resinous material of a desired resin color so as to blend in with a color of the natural stone surface; and
polishing the resultant seam so as to blend said seam so as not to be readily noticeable.

5. The method according to claim 4, wherein the natural stone prefabricated edge has a thickness equal to or greater than a thickness of the natural stone surface.

6. The method according to claim 1, wherein said desired thickness of the natural stone surface is about ½ inch thick.

7. The method according to claim 4, wherein the natural stone prefabricated edge has a thickness of about 2 cm to about 15 cm.
